(19) United States
(12) Patent Application Publication
(10) Pub. No.: US 2018/0324305 A1
(43) Pub. Date: Nov. 8, 2018

(54) SYSTEM AND METHOD FOR SETTING UP A GROUP CALL

(71) Applicant: Rebtel Networks AB, Stockholm (SE)

(72) Inventors: Johan Dahlqvist, Bromma (SE); Vasco Preto, Järfälla (SE); Andrew Kaminski, Täby (US); Thomas Kyritsis, Sollentuna (SE); Pär Lindhe, Hägersten (US); Thomas Skoglund, Stockholm (SE); Suresh Kumar, Norsborg (SE); Amir Mortazavi, Solna (SE); Christopher Connor, Stockholm (SE)

(21) Appl. No.: 15/769,199

(22) PCT Filed: Oct. 10, 2016
(86) PCT No.: PCT/EP2016/074165

§ 371 Date: Apr. 18, 2018

(30) Foreign Application Priority Data
Oct. 19, 2015 (EP) 15190378.8

(51) Int. Cl. H04M 3/56; H04M 3/02

(52) U.S. Cl. CPC H04M 3/56; H04W 84/042; H04M 3/02

(57) ABSTRACT

A group call is setup between one originating device (A) and at least two terminating devices (B, C), which each has access to a public land mobile network (131, 132, 133) and a mobile data net-work (121, 122, 123). The originating and terminating devices (A, B, C) include a respective software-implemented call handling tool (SWA, SWB, SWC) configured to assist a user in placing and receiving group calls. Bridge nodes (141, 142, 143) are connected to the mobile data network (121, 122, 123), the public land mobile network (131, 132, 133) and a server node (110), which, in turn, also is connected to the mobile data network (121, 122, 123). In response to a call-setup command from a user of the originating device (A), the software-implemented call handling tool (SWA), on one hand, sends a call-setup request (1) to the server node (110); and on the other hand, makes a first call (2) to a first bridge node (141) over the public land mobile network (131) using a first telephone number (#1) stored in the originating device (A). The call-setup request (1) indicates an identity of the terminating devices (B, C). Based on the call-setup request (1) and the first call (2), the server node (110) sets up a call between the originating and terminating devices (A, B, C) over a conference bridge (146) in the first bridge node (141), plus possibly other bridge nodes (147, 148) depending on where the devices (A, B, C) are located relative to one another.

### THE BACKGROUND OF THE INVENTION AND PRIOR ART

The present invention relates generally to cost-efficient setup of group calls between mobile terminals. More particularly the invention relates to a system according to the preamble of claim 1 and a corresponding method. The invention also relates to a computer program product and a processor-readable medium.

Since an increasing amount of voice traffic is now being conveyed over the Internet, the telephone charges are gradually lowered. For example, the pricing structure for both landline and mobile phone calls within a specific operator's network, country and/or region is often such that a flat rate applies regardless of usage. Typically, however, long distance calls are still relatively expensive, even though this may not be fully justified from a technical point-of-view. In particular, group calls, i.e. voice calls including three or more parties, may become very expensive if the parties involved are located in different countries. Therefore, various group-call solutions have been developed, which involve Internet-based technology, and aim at reducing the costs.

U.S. Pat. No. 6,256,389 shows an integrated telecommunication collaboration system, which allows close integration of desktop computer applications, data communications and public switched telephone network voice connections. Here, client software includes a voice agent for establishing telephone sessions, a data agent for establishing associated data sessions, a communications agent which synchronizes the data and voice agents, and an integration agent which integrates the data and voice communications with a computer operating system and with various applications. The integrated telecommunication collaboration system controls the establishment of harmonized calls by sending and receiving various requests and status messages to and from a server and another client.

US 2013/0331075 describes methods, systems and devices for joining a conference call on an electronic device. Methods are described which include steps of receiving a communication and determining at least one replacement conference call phone number based on information in the communication. Further steps may involve determining that the replacement conference call phone number is a preferred conference call phone number. Moreover, steps may be included that involves initiating a dialling sequence using the preferred conference call phone number.

U.S. Pat. No. 7,209,947 discloses a system and method for providing data network-assisted conference service to a wireless terminal. Conference-related information is here received from a conference originator and stored. Prior to conference establishment time, a conference notification message is sent to the wireless terminal. A conference connection request is sent by the wireless terminal in response to the conference notification message, and a conference connection is established between the wireless terminal and a conference bridge that connects all conference participants.

US 2014/0362742 reveals a solution for facilitating the set-up of a conference call over a telecommunication network, where the call is between a first user and a one or more second users of the network. For example, via the solution, a user can establish a conference call in a very short time and easy way. In addition, he/she is able to book and manage their conferences through a smartphone app, or a mail server client.

### PROBLEMS ASSOCIATED WITH THE PRIOR ART

Thus, various cost-efficient solutions are known for setting up group calls, inter alia based on conference bridges. However, these solutions have one thing in common, namely they are relatively complicated to implement, especially for mobile subscribers.

### SUMMARY OF THE INVENTION

The object of the present invention is therefore to alleviate the above problem, and offer a cost-efficient, reliable and user-friendly group-calling solution for mobile users, which can be applied in a straightforward manner regardless of whether the parties involved are located in the same network, or on different continents.

According to one aspect of the invention, the object is achieved by the initially described system, wherein in response to the user-generated call-setup command, the software-implemented call handling tool in the originating device is also configured to make a first call to a first bridge node over the public land mobile network (PLMN) using a first telephone number stored in the originating device.

This system is advantageous because the signaling relating to the voice connection to be established over the PLMN can be performed independently from the signaling involving the server node, which aims at paging the terminating devices and informing their users of the incoming group call. Thus, the overall call setup can be made highly efficient. In fact, depending on the latencies in the different networks, the terminating devices may even establish connections with a bridge node before the originating device does so.

According to one preferred embodiment of this aspect of the invention, the originating device contains a set of different telephone numbers, and the software-implemented call handling tool in the originating device is configured to select the first telephone number based on a location of the originating device. Thereby, for instance, the first call can be made to a geographically nearest first bridge node, which is normally advantageous from a cost point-of-view.

According to another preferred embodiment of this aspect of the invention, in response to the first call, the first bridge node, in turn, is configured to send a first bridge-acknowledge message to the server node. The first bridge-acknowledge message specifies a first network address of the first bridge node. Hence, the first bridge-acknowledge message informs the server node about which primary bridge node that will be employed for setting up the group call.

According to yet another preferred embodiment of this aspect of the invention, in response to the call-setup request, the server node, in turn, is configured to send a respective service message to each of the terminating devices. The service messages indicate an identity of the originating device and a petition to establish a voice connection with the terminating devices. Consequently, the service messages inform the terminating device of the incoming call from the originating device.

Preferably, in response to a received service message, the software-implemented call handling tool in a terminating device is configured to generate an alert signal, which is adapted to notify a user of the terminating device of the incoming call from the originating device. For example, the alert signal may involve producing an acoustic signal, a text message, graphics and/or an optic signal.

According to a further preferred embodiment of this aspect of the invention, after having started to generate the alert signal, the software-implemented call handling tool in each of the terminating devices is configured to make a reply call to a second bridge node in response to a user's accept command. Here, the accept command may for example be represented by activation of: an on-screen input means, a key or a button, or by a voice command. The reply call is made over the public land mobile network using a second telephone number, which preferably is stored in the respective terminating device. In fact, the second telephone number may be identical to the first telephone number.

Thus, in a simplest possible implementation of the invention, all devices only store a single telephone number, which is used by the software-implemented call handling tool both for placing calls and accepting incoming calls.

However, according to a preferred embodiment of this aspect of the invention, each terminating device contains a set of different telephone numbers, and the software-implemented call handling tool is configured to select the second telephone number based on a location of the terminating device. Thereby, analogous to the first call, the reply calls can made to a second bridge node that is a geographically nearest to each of the terminating devices. Further preferably, if possible, each reply call is made to a second bridge node within a home network of the terminating device in question. Namely, this is most advantageous from a cost point-of-view.

According to still another preferred embodiment of this aspect of the invention, in response to the reply call, each second bridge node, in turn, is configured to send a respective second bridge-acknowledge message to the server node. The second bridge-acknowledge message specifies a second network address of the second bridge node. Thus, based on the second bridge-acknowledge message, the server node is informed of which second bridge nodes that will be used to set up the call to the terminating devices. In response to the first and second bridge-acknowledge messages, the server node is configured to send bridge-prompting messages to the first and second bridge nodes respectively. Consequently, it is confirmed to the first and second bridge nodes in a simple and straightforward manner that a call will be set up between the originating and terminating devices using the thus identified first and second bridge nodes.

According to another preferred embodiment of this aspect of the invention, in response to the bridge-prompting messages, the first and second bridge nodes are configured to cause connections to be established between the originating device and each of the terminating devices over the conference bridges. In practice, this typically means that once the call has been set up to a particular device, a respective connection is established directly between each device and the first conference bridge. I.e., the payload traffic will go exclusively through the first bridge node, which, normally, is located relatively near the originating device.

According to a further preferred embodiment of this aspect of the invention, if a connection has been established between the originating device and at least one first device of the at least two terminating devices, and no user's accept command has been received in at least one non-connected device of the called terminating devices within a response interval after having initiated the first type of alert signal; the server node is configured to send a call-in-progress notification to the non-connected device(s). In response to this notification, the software-implemented call handling tool in the one non-connected device(s) is configured to generate a second type of alert signal. This signal, in turn, is adapted to notify a user of an ongoing call to which he/she may choose to connect. Thus, in the event that a callee missed to accept the initial call invitation, he/she may conveniently join the conversation at any time later as long as the call is still in progress.

According to yet another preferred embodiment of this aspect of the invention, a database that is accessible by the server node stores a definition of a group of subscribers. Each of the subscribers in the group is associated with a particular device, and if a connection has been established between a set of devices associated with a sub-group of subscribers within the group, the server node is configured to send a call-in-progress notification to each non-connected device that is associated with a subscriber of the group, however that is not included in the sub-group. In response to the call-in-progress notification, the software-implemented call handling tool in each of the non-connected devices is configured to generate a second type of alert signal, which is adapted to notify a user of an ongoing call to which the non-connected device can be connected. Hence, even if a party was not actually called, he/she may choose to join an ongoing group call provided that the user in question belongs to the group in name of which the call was initiated.

Preferably, in response to a received user command designating the ongoing call, the software-implemented call handling tool in the non-connected device is configured to make the reply call to the second bridge node of the at least one bridge node over the public land mobile network using the reply telephone number, i.e. as if the call had been answered in connection with the original call setup.

According to still another preferred embodiment of this aspect of the invention, after that a group call has been set up between the originating device and at least two terminating devices, the software-implemented call handling tool in each of said devices is configured to provide the parties with a set of call-related services. Specifically, via the software-implemented call handling tool, a user may: generate a call-setup request in respect of at least one additional terminating device to be included in the group call in response to a call-setup command from a user; send a call-disconnect request in respect of at least one of said devices to the server node, and/or send a mute request in respect of at least one of said devices to the server node. Thereby, the group-call parties are given a useful toolbox for handling various situations as the call is in progress.

According to another aspect of the invention, the object is achieved by the method described initially, which further involves making, via the software-implemented call handling tool in the originating device, a first call to a first bridge node. The first call is made in response to the call-setup command, and is effected over PLMN using a first telephone number that is stored in the originating device. The advantages of this method, as well as the preferred embodiments thereof, are apparent from the discussion above with reference to the proposed diagnostic apparatus.

According to a further aspect of the invention the object is achieved by a computer program product loadable into the memory of at least one processor, and includes software adapted to implement the method proposed above when said program is run on at least one processor.

According to another aspect of the invention the object is achieved by a processor-readable medium, having a program recorded thereon, where the program is to control at least one processor to perform the method proposed above when the program is loaded into the at least one processor.

Further advantages, beneficial features and applications of the present invention will be apparent from the following description and the dependent claims.

### BRIEF DESCRIPTION OF THE DRAWINGS

The invention is now to be explained more closely by means of preferred embodiments, which are disclosed as examples, and with reference to the attached drawings.

FIG. 1 shows an overview of a system according to one embodiment of the invention; and

FIG. 2 illustrates, by means of a flow diagram, the general method according to the invention.

### DESCRIPTION OF PREFERRED EMBODIMENTS OF THE INVENTION

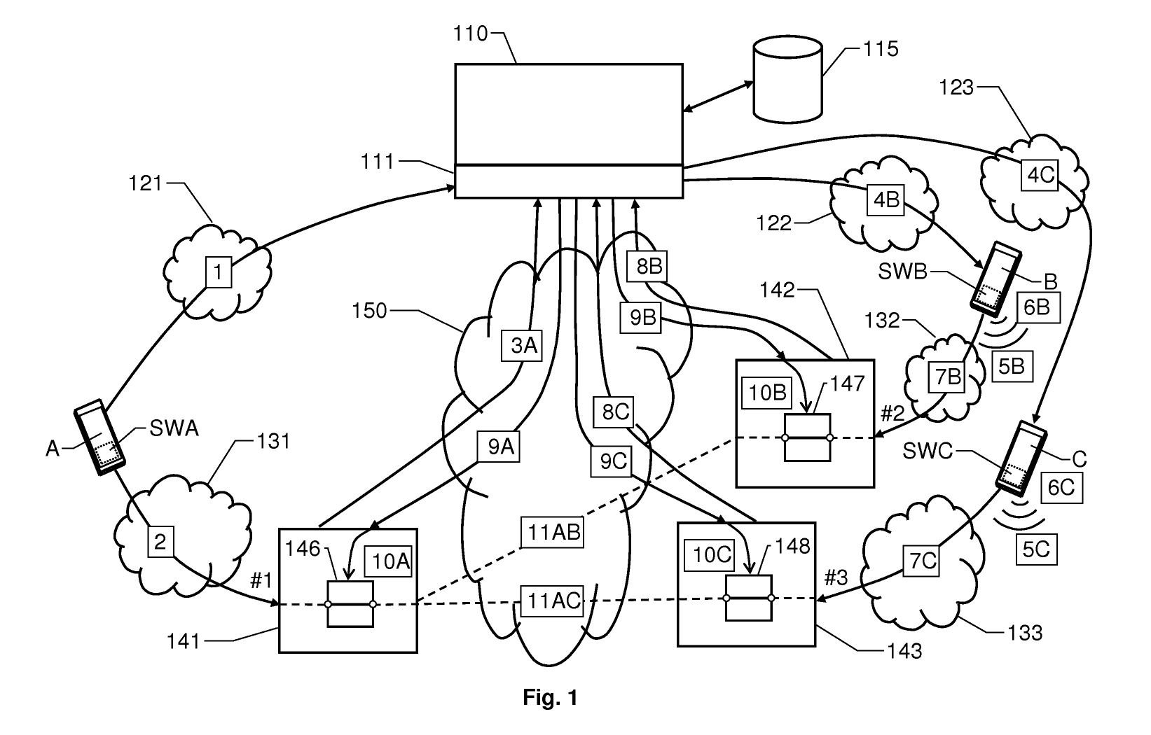

Initially, we refer to FIG. 1, which shows an overview of a system according to one embodiment of the invention for setting up a group call between one originating device A and at least two terminating devices B and C respectively. The originating and terminating devices A, B and C each has access to a PLMN 131, 132 and 133 respectively as well as a mobile data network 121, 122 and 123 respectively via one or more respective wireless interfaces, e.g. based on radio, optic or inductive technology.

Here, the originating device A is presumed to have access to a first PLMN 131. Analogously, the terminating devices are presumed to have access to second and third PLMN:s 132 and 133 respectively. Furthermore, the devices A, B and C are presumed to have access to first, second and third mobile data networks 121, 122 and 123 respectively. Each of the mobile data networks 121, 122 and 123, in turn, is connected to at least one respective bridge node 141, 142 and 143. The bridge nodes 141, 142 and 143 are further connected to a data network 150, e.g. the Internet

Moreover, the devices A, B and C include a respective software-implemented call handling tool SWA, SWB and SWC, e.g. a so-called app, which is configured to assist a user in the process of placing and receiving group calls.

The proposed system further includes a server node 110, which is connected to the mobile data networks 121, 122 and 123 as well as to the data network 150. Hence, the server node 110 may communicate with the bridge nodes 141, 142 and 143 over the data network 150.

According to the invention, a first user who wants to make a group call to second and third users associated with the devices B and C respectively generates a call-setup command in the originating device A, which call setup command identifies the second and third users, for instance via their telephone numbers. Alternatively, the first user may select a predefined group in the software-implemented call handling tool SWA, which group includes the second and third users. Thereby, a group call is automatically set up to all the members of that group. Further details regarding this process will be described below.

In any case, each of the devices A, B and C is adapted for wireless voice communication over at least one mobile telephone interface, e.g. in accordance with any of the standards: GSM (Global System for Mobile Communications/Groupe Special Mobile), CDMA2000, UMB (Ultra Mobile Broadband) LTE (Long-Term Evolution), UMTS (Universal Mobile Telecommunications System), and/or GAN (Generic Access Network). Moreover, each of the devices A, B and C is adapted for wireless data communication, e.g. in accordance with any of the standards: GPRS (General packet radio service), EDGE (Enhanced Data rates for GSM Evolution), HSPA (High Speed Packet Access), HSPA+ (Evolved High-Speed Packet Access) and/or WLAN/Wireless Ethernet of the IEEE 802.11 family (so-called WiFi). Consequently, the devices A, B and C may be represented e.g. by smartphones, tablets, PDA:s (personal digital assistant) or laptops.

In response to the call-setup command, the software-implemented call handling tool SWA in the originating device A is configured to send a call-setup request 1 from the originating device A to the server node 110 over the first mobile data network 121. The call-setup request 1 indicates identities of the terminating devices B and C, such as their telephone numbers.

In response to the call-setup command, the software-implemented call handling tool SWA in the originating device A is also configured to make a first call 2 to a first bridge node 141 that is connected to the first PLMN 131 using a first telephone number #1 stored in the originating device A.

The server node 110, in turn, is configured to receive the call-set-up request 1, preferably via an application programming interface (API) 111, and based thereon, set up a call between the originating device A and the terminating devices B and C over at least one conference bridge 146 in the bridge node 141. This process will be described in further detail below.

Preferably, the originating device A contains a set of different first telephone numbers #1, and the software-implemented call handling tool SWA is configured to select a particular first telephone number #1 based on a current location of the originating device A. Thereby, the first call 2 can for example be made to the bridge node 141, which is geographically nearest to the originating ting device A; or more preferably, to a physically nearest bridge node 141 that is also connected to the PLMN 131 to which the originating device A is currently attached.

The server node 110 is preferably communicatively connected to a database 115 storing data about all registered users in the system, including the subscribers associated with the devices A, B and C. Thereby, upon receipt of the call-setup request 1, the server node 110 may verify that the users involved are authorized, and thus allow a group call to be set up. It is further advantageous if the server node 110 is configured to repeatedly feedback updated data from the database 115 to the devices A, B and C, or more precisely to all subscribers in the system, concerning which of the contacts in a particular device's contact list who has a subscription with the system (i.e. that is listed in the database 115). Namely, thereby, the software-implemented call handling tool SWA may be arranged to (i) indicate whether or not a contact in the device's contact list is available via the system and/or (ii) automatically choose to setup any group call via the system to callees who are available through this system.

The software-implemented call handling tool SWA in the originating device A is configured to make the first call 2 prior to sending the call-setup request 1 to the server node 110; or in parallel with, or after, sending the call-setup request 1 to the server node 110. Generally, to minimize the call-setup time, it is desirable that the call-setup request 1 is sent out and the first call 2 is made as soon as possible. However, in some technical environment it is necessary that there is a certain temporal relationship between them. It is therefore advantageous that the invention offers full freedom in terms of whether the call-setup request 1 is sent out before, in parallel with or after that the first call 2 is made.

In any case, in response to the first call 2, the bridge node 141 is configured to send a first bridge-acknowledge message 3A to the server node 110. The first bridge-acknowledge message 3A specifies a first network address of the bridge node 141 so as to inform the server node 110 of the identity of the bridge node 141.

In response to the call-setup request 1, the server node 110 is configured to send a respective service message 4B and 4C to each of the terminating devices B and C. The service messages 4B and 4C indicate an identity of the originating device A, for instance a caller line identification (CLI), and a petition to establish a group-call connection with the terminating devices B and C respectively.

In response to the service message 4B and 4C, each of the software-implemented call handling tools SWB and SWC in the terminating devices B and C is configured to generate an alert signal 5B and 5C that is adapted to notify a user of the device of an incoming call from the originating device A, for example by producing an acoustic signal, showing a text message on a display, showing graphics on a display, activating a light source and/or causing the device to vibrate.

After having initiated the alert signal 5B and 5C respectively, the software-implemented call handling tools SWB and SWC are configured to wait for a respective accept command 6B or 6C from the user of the device. If such an accept command 6B/6C is received in the terminating device B and/or C, the software-implemented call handling tool SWB and/or SWC respectively is configured to make a reply call 7B and/or 7C to a bridge node 142 and/or 143 respectively.

Alternatively, the software-implemented call handling tools SWB and SWC may be configured to make the reply call 7B and 7C to the bridge nodes 142 and 143 respectively at any time after receiving the service message 4B and 4C respectively. I.e. the reply calls 7B and/or 7C can be made before the terminating device users accept 6B and 6C the incoming call. This is advantageous because it reduces the overall delay until a connection between the devices A, B and C can be established. At the same time, no costs will result from the reply calls 7B or 7C if the associated device user rejects the incoming call, or does not accept it before the originating device A user hangs up. In fact, if no connection is established between the devices A, B and C, no costs will result on the originating side either. In other words, if all the terminating device users reject the incoming call, or none of them accepts the call before the originating device user hangs up, the subscription associated with the originating device A will not be charged for first call 2 to the bridge node 141. Namely, the first call 2 is answered only if at least one of the reply calls 7B and/or 7C reaches the bridge node 142 and/or 143. According to standard telecommunication billing routines, no charge is incurred for either party unless at least two parties arrive at a bridge node 141, 142 and/or 143 since it is only at this point in time that the call is answered.

The reply calls 7B and 7C are made over the PLMN, here represented by 132 and 133 respectively, using reply telephone numbers #2 and #3 respectively, which preferably are stored in the terminating devices B and C respectively, and may either be fixed or be selected dynamically, e.g. based on the respective locations of the terminating devices B and C. In the former case, the reply telephone numbers #2 and #3 can be default numbers, which could be the same as the first telephone number #1. In the latter case, however, the reply telephone numbers #2 and #3 are typically different from the first telephone number #1.

In response to the reply calls 7B and 7C, the bridge nodes 142 and 143 are configured to send a respective second bridge-acknowledge message 8B and 8C to the server node 110. Each second bridge-acknowledge message 8B and 8C specifies a second network address of the bridge node 142 and 143 respectively. In response to the first and second bridge-acknowledge messages 3A, 8B and 8C, the server node 110, in turn, is configured to send a respective bridge-prompting message 9A, 9B and 9C to each of the bridge nodes 141, 142 and 143 respectively. Thereafter, the interconnection of the originating device A and terminating devices B and C can be completed via first and second legs 11AB and 11AC respectively over the network 150 between the bridge nodes 141, 142 and 143.

Preferably, to economize the bridge-node resources, upon receipt of the bridge-prompting message 9B in the bridge node 142, the bridge node 142 is configured to cause 10B a direct connection between the originating device A and the terminating device B over the conference bridge 146 in the bridge node 141 and the PLMN 132, i.e. bypassing the bridge node 142. Analogously, upon receipt of the bridge-prompting message 9C in the bridge node 143, the bridge node 143 is configured to cause 100 a direct connection between the originating device A and the terminating device C over the conference bridge 146 in the bridge node 141 and the PLMN 133, i.e. bypassing the bridge node 143.

The server node 110 and the bridge nodes 141, 142 and 143 are preferably communicatively connected to at least one memory unit storing a computer program product, which, in turn, contains software for making at least one processor in the server node 110 and the bridge nodes 141, 142 and 143 execute the above-described actions together with the software-implemented call handling tools SWA, SWB and SWC when the computer program product is run on the at least one processor.

The database 115 may further store definitions of groups of subscribers, which groups are used for setting up calls to predefined clusters of subscribers or by other means handling calls that include such clusters of subscribers. Each of the subscribers in a group of subscribers is presumed to be associated with a particular device, for instance A, B or C. Thus, given that there is a group of subscribers associated with the devices A, B and C, the originating device may initiate a group call in respect of that group simply by selecting a corresponding icon in the software-implemented call handling tool SWA.

Of course, especially if there are many members of the group, there is a risk that only a sub-set of the members accept an incoming call within an interval for accept. Therefore, according to one preferred embodiment of the invention, if a connection 11AB has been established between the originating device A and at least one terminating device B of the terminating devices identified in the call-setup request 1, however no user's accept command has been received in at least one of the other terminating devices C identified in the call-setup request 1 within a response interval after having initiated the first type of alert signal 5C, the server node 110 is configured to send a call-in-progress notification to each such non-connected device C. In response to the call-in-progress notification, the software-implemented call handling tool SWC in the non-connected device C is configured to generate a second type of alert signal adapted to notify a user of an ongoing call to which the non-connected device C can be connected.

Further preferably, if a connection 11AC has been established between a set of devices, say A and C, associated with a sub-group of subscribers in a group of subscribers, the server node 110 is configured to send a call-in-progress notification to each non-connected device B that is associated with a subscriber of the group, however that is not included in the sub-group. In other words, also subscribers who were never actually called, but belong to a group in which some members are engaged in a call may be informed of an ongoing group call. In response to the call-in-progress notification, the software-implemented call handling tool SWB in each of the non-connected devices, here B, is configured to generate a second type of alert signal adapted to notify a user of an ongoing call to which the non-connected device B can be connected. In response to a received user command designating the ongoing call, in turn, the software-implemented call handling tool SWB in the non-connected device B is configured to make the reply call 7B to the second bridge node 142 over the public land mobile network 132 using the reply telephone number #2 as described above.

Additionally, after that a group call has been set up between the originating device A and the at least two terminating devices B and C, it is preferable if the software-implemented call handling tool SWA, SWB and SWC respectively is configured to implement further call-related services. For example, this may involve gene-rating a call-setup request 1 in respect of at least one additional terminating device to be included in the group call in response to a call-setup command from a user. In other words, any user of the devices A, B and/or C can invite further participants to the group call during the course of the call.

Alternatively, or additionally, the software-implemented call handling tool SWA, SWB and SWC respectively may be configured to send a call-disconnect request in respect of at least one of the other devices A, B and/or C to the server node 110 in response to a call-disconnect command from a user. Upon receipt of such a request, the server node 110, in turn, is configured to cause a device specified in the call-disconnect request to be disconnected from the group call.

Alternatively, or additionally, the software-implemented call handling tool SWA, SWB and SWC respectively may be configured to send a mute request in respect of at least one of the other devices A, B and/or C to the server node 110 in response to a muting command from a user. Upon receipt of such a request, the server node 110, in turn, is configured to cause a temporary interruption in an exchange of acoustic data between a device specified in the mute request and the other devices of said devices.

As yet another alternative, the software-implemented call handling tool SWA, SWB and SWC respectively may be configured to send an on-hold request in respect of at least one of the other devices A, B and/or C to the server node 110 in response to an on-hold command from a user. Upon receipt of such a request, the server node 110, in turn, is configured to temporary disconnect any device specified in the on-hold request from all incoming and outgoing acoustic data that is exchanged between the other parties on the line. In other words, a sub-group within the group is placed on hold while the remaining participants have a private talk session.

The server node 110 and the bridge nodes 141, 142 and 143 are preferably communicatively connected to at least one memory unit storing a computer program product, which, in turn, contains software for making at least one processor in the server node 110 and the bridge nodes 141, 142 and 143 a execute the above-described actions together with the software-implemented call handling tools SWA and SWB when the computer program product is run on the at least one processor.

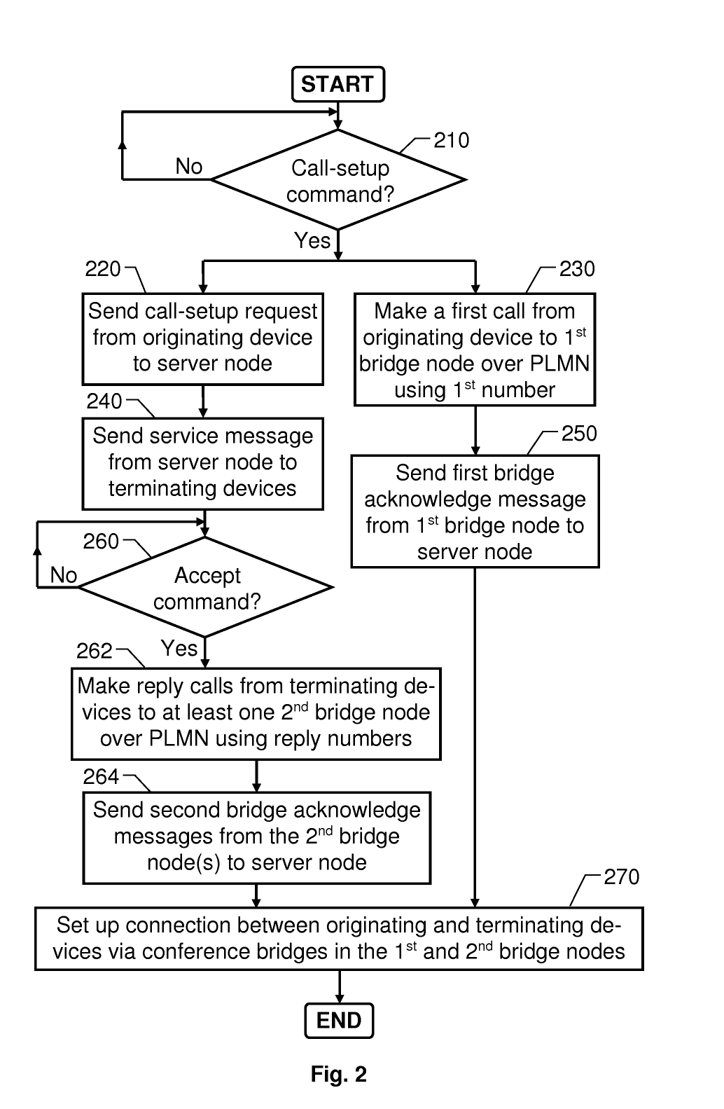

In order to sum up, and with reference to the flow diagram in FIG. 2, we will now describe the general method according to the invention for setting up a group call between one originating device and at least two terminating devices, which each has access to a PLMN as well as to a mobile data network.

A first step 210, checks if a call-setup command has been received in the originating device; and if so, parallel steps 220 and 230 follow. Otherwise, the procedure loops back and stays in step 210.

In step 220, a call-setup request is sent from the originating device to the server node over a first mobile data network. In step 230, a first call is made over PLMN from the originating device to a first bridge node using a first telephone number.

A step 240, subsequent to step 220, involves sending a respective service message from the server node to the terminating devices. A step 250, following step 230, involves sending a first bridge acknowledge message from the first bridge to the server node over a data network, e.g. the Internet.

A step 260, succeeding step 240, checks if the incoming call has been accepted in a terminating device; and if so a step 262 follows. Otherwise, in respect of each terminating device from which no call accept has been received, the procedure loops back and stays in step 260 until a timer expires (i.e. the call remains unaccepted for a certain time).

In step 262, a reply call is made from each accepting terminating device to a second bridge node. Then, in a step 264, a second bridge acknowledge message is sent from each second bridge node to the server node over a data network, e.g. the Internet.

A step 270, which follows after parallel steps 264 and 270, sets up connections between the originating and terminating devices via conference bridges in the first and second bridge nodes. Thereafter, the call-setup procedure ends. However, the group call, as such, is active until at least two of the devices involved remain connected.

All of the process steps, as well as any sub-sequence of steps, described with reference to FIG. 2 above may be controlled by means of a programmed processor. Moreover, although the embodiments of the invention described above with reference to the drawings comprise processor and processes performed in at least one processor, the invention thus also extends to computer programs, particularly computer programs on or in a carrier, adapted for putting the invention into practice. The program may be in the form of source code, object code, a code intermediate source and object code such as in partially compiled form, or in any other form suitable for use in the implementation of the process according to the invention. The program may either be a part of an operating system, or be a separate application. The carrier may be any entity or device capable of carrying the program. For example, the carrier may comprise a storage medium, such as a Flash memory, a ROM (Read Only Memory), for example a DVD (Digital Video/Versatile Disk), a CD (Compact Disc) or a semi-conductor ROM, an EPROM (Erasable Programmable Read-Only Memory), an EEPROM (Electrically Erasable Programmable Read-Only Memory), or a magnetic recording medium, for example a floppy disc or hard disc. Further, the carrier may be a transmissible carrier such as an electrical or optical signal which may be conveyed via electrical or optical cable or by radio or by other means. When the program is embodied in a signal which may be conveyed directly by a cable or other device or means, the carrier may be constituted by such cable or device or means. Alternatively, the carrier may be an integrated circuit in which the program is embedded, the integrated circuit being adapted for performing, or for use in the performance of, the relevant processes.

The term “comprises/comprising” when used in this specification is taken to specify the presence of stated features, integers, steps or components. However, the term does not preclude the presence or addition of one or more additional features, integers, steps or components or groups thereof.

The invention is not restricted to the described embodiments in the figures, but may be varied freely within the scope of the claims.

1. A system for setting up a group call between one originating device and at least two terminating devices, the originating and terminating devices each having access both to a public land mobile network and a mobile data network, the originating and terminating devices including a respective software-implemented call handling tool configured to assist a user in the process of placing and receiving group calls, the system comprising:
a server node connected to the mobile data network, and
at least one bridge node connected to the server node, the mobile data network and the public land mobile network,
the server node being configured to:
receive a call-setup request from the originating device, the call-setup request being generated by the software-implemented call handling tool in the originating device in response to a call-setup command from a user of the originating device, the call-setup request indicating a respective identity of the at least two terminating devices, and
based on the call-setup request, set up a group call between the originating device and the at least two terminating devices over at least one conference bridge in the at least one bridge node,
wherein in response to the call-setup command, the software-implemented call handling tool in the originating device is further configured to make a first call to a first bridge node of the at least one bridge node over the public land mobile network using a first telephone number stored in the originating device.

2. The system according to claim 1, wherein the software-implemented call handling tool in the originating device is configured to select the first telephone number based on a location of the originating device.

3. The system according to claim 1, wherein, in response to the first call, the first bridge node is configured to send a first bridge-acknowledge message to the server node, the first bridge-acknowledge message specifying a first network address of the first bridge node.

4. The system according to claim 1, wherein, in response to the call-setup request, the server node is configured to send a respective service message to each of the at least two terminating devices, the service messages indicating an identity of the originating device and a petition to establish a voice connection with the at least two terminating devices.

5. The system according to claim 4, wherein, in response to the service messages, the software-implemented call handling tool in each of the at least two terminating devices is configured to generate a first type of alert signal adapted to notify a user of an incoming group call from the originating device.

6. The system according to claim 5, wherein, after having initiated the first type of alert signal, the software-implemented call handling tool in each of the at least two terminating devices is configured to make a reply call to at least one second bridge node of the at least one bridge node in response to a respective user's accept command, the reply calls being made over the public land mobile network using a respective reply telephone number.

7. The system according to claim 6, wherein the software-implemented call handling tool in each of the terminating devices is configured to select the reply telephone number based on a respective location of the terminating device.

8. The system according to claim 6, wherein the reply telephone number is stored in the terminating device.

9. The system according to claim 6, wherein, in response to the reply call, the at least one second bridge node is configured to send a second bridge-acknowledge message to the server node, the second bridge-acknowledge message specifying a second network address of the second bridge node; and
in response to the first and second bridge-acknowledge messages, the server node is configured to send a respective bridge-prompting message to the first and second bridge nodes.

10. The system according to claim 9, wherein, in response to the bridge-prompting messages, the first and second bridge nodes are configured to cause connections between the originating device and the at least two terminating device over the at least one conference bridge.

11. The system according to claim 10, wherein if:
a connection has been established between the originating device and at least one first device of the at least two terminating devices, and
no user's accept command has been received in at least one non-connected device of the at least two terminating devices within a response interval after having initiated the first type of alert signal,
the server node is configured to send a call-in-progress notification to the at least one non-connected device, and
in response thereto, the software-implemented call handling tool in the at least one non-connected device is configured to generate a second type of alert signal adapted to notify a user of an ongoing call to which the at least one non-connected device can be connected.

12. The system according to claim 10, wherein a definition of a group of subscribers is stored in a database accessible by the server node, each of the subscribers in the group of subscribers being associated with a particular device, and if a connection has been established between a set of devices associated with a sub-group of subscribers in the group of subscribers,
the server node is configured to send a call-in-progress notification to each non-connected device that is associated with a subscriber of the group however that is not included in the sub-group, and in response thereto
the software-implemented call handling tool in each of the non-connected devices is configured to generate a second type of alert signal adapted to notify a user of an ongoing call to which the non-connected device can be connected.

13. The system according to claim 11, wherein in response to a received user command designating the ongoing call, the software-implemented call handling tool in the non-connected device is configured to make the reply call to the second bridge node of the at least one bridge node over the public land mobile network using the reply telephone number.

14. The system according to claim 1, wherein after that a group call has been set up between the originating device and the at least two terminating devices, the software-implemented call handling tool in each of said devices is configured to:
generate the call-setup request in respect of at least one additional terminating device to be included in the group call in response to a call-setup command from a user,
send a call-disconnect request in respect of at least one of said devices to the server node in response to a call-disconnect command from a user, the server node being configured to cause a device specified in the call-disconnect request to be disconnected from the group call, or
send a mute request in respect of at least one of said devices to the server node in response to a muting command from a user, the server node being configured to cause a temporary interruption in an exchange of acoustic data between a device specified in the mute request and the other devices of said devices.

15. A method of setting up a group call between one originating device and at least two terminating devices, the originating and terminating devices each having access both to a public land mobile network and a mobile data network, the originating and terminating devices including a respective software-implemented call handling tool configured to assist a user in the process of placing and receiving group calls, the system comprising: a server node connected to the mobile data network, and at least one bridge node connected to the server node, the mobile data network and the public land mobile network, the method comprising:
receiving in the server node a call-setup request from the originating device, the call-setup request being generated by the software-implemented call handling tool in the originating device in response to a call-setup command from a user of the originating device, the call-setup request indicating a respective identity of the at least two terminating devices, and
based on the call-setup request, setting up a group call between the originating device and the at least two terminating devices over at least one conference bridge in the at least one bridge node, wherein
making, via the software-implemented call handling tool in the originating device, a first call to a first bridge node of the at least one bridge node over the public land mobile network using a first telephone number stored in the originating device in response to the call-setup command.

16. The method according to claim 15, comprising:
selecting, via the software-implemented call handling tool in the originating device, the first telephone number based on a location of the originating device.

17. The method according to claim 15, comprising:
sending, in response to the first call, a first bridge-acknowledge message from the first bridge node to the server node, the first bridge-acknowledge message specifying a first network address of the first bridge node.

18. The method according to claim 15, comprising:
sending from the server node, in response to the call-setup request, a respective service message to each of the at least one terminating device, the service messages indicating an identity of the originating device and a petition to establish a voice connection with the at least two terminating devices.

19-29. (canceled)

30. A computer program product loadable into the memory of at least one processor, comprising software for executing the method of claim 15, when said computer program product is run on the at least one processor.

31. A processor-readable medium comprising instructions which, when executed by at least one processor, cause the at least one processor to perform a method according to claim 15.
